(19) United States
(12) Patent Application Publication
(10) Pub. No.: US 2012/0118514 A1
(43) Pub. Date: May 17, 2012

(54) ENERGY CONTROL DEVICE FOR WINDOWS AND THE LIKE

(76) Inventor: Brian John Howard Hughes, Newport (GB)

(21) Appl. No.: 13/376,832

(22) PCT Filed: May 21, 2010
(86) PCT No.: PCT/GB2010/050841

§ 371 Date: Dec. 30, 2011

(30) Foreign Application Priority Data
May 21, 2009 (GB) 0908745.3

(51) Int. Cl. E06B 9/264; E06B 9/386; E06B 9/44

(52) U.S. Cl. 160/25; 160/107; 160/98; 160/133; 160/238

(57) ABSTRACT

A device for fitting to a window or other glazing panel comprises first and second parallel rollers disposed at spaced apart positions on opposite sides of the device and an elongate substrate sheet extending between the rollers, the substrate sheet being provided at its upper end with a series of spatially separated optical elements arranged to reflect incident sunlight upwardly. The lower end of the substrate is free of elements and is preferably formed of a material which controls the amount of long wave infra-red radiation leaving the room in which the window is provided. The position of the ends of the substrate can be varied by turning the rollers to variably control the solar energy entering a building and to control the amount heat exiting the room. The device may also provide a sealed air gap across the window to act as a thermal barrier.

This invention relates to a device that can variably control solar energy in the form of glare and solar heat gain caused by sunlight entering or travelling through a glazed assembly such as a window into the interior of a building and to also control energy in the form of heat exiting the building through the glazed assembly.

It is well known to mount horizontal slats in the form of Venetian blinds across the rear of glazing panels on buildings in order to attenuate and redirect the sunlight. Such blinds are only a temporary solution to the problem and their effect is dependant on them being lowered and correctly adjusted.

It is also well known to mount permanent horizontal slats across the front of glazing panels on some buildings in order to attenuate and redirect the sunlight. Such so-called brise soleil or are expensive in construction, unsightly and heavy as well as being difficult to clean and maintain. Once such brise soleil is disclosed in Taiwanese Patent Application TW552344B.

My co-pending International Patent Application published under the serial number WO2008/096176 and which is hereby incorporated herein by reference, discloses a glazing panel which alleviates the above mentioned problems and comprises a sheet of glass and a series of spatially separated optical elements disposed on a major face of the glass, each element having an optical transmission coefficient which varies across its width, parallel to the plane of the glass, from a first side to a second side thereof, the first side being less optically transmissive than the second side. The thickness of each element, perpendicular to the plane of the glass, is greater at said first side thereof than the second side thereof, the first side of each element comprising a reflective side face directed generally parallel to the plane of the glass and facing in substantially the same direction as adjacent elements of the series.

In use, the glazing panel is installed such that the reflective side faces of the elements face generally upwardly. As sunlight shines downwardly from the sky above onto one side of the glazing panel, the light incident on the upwardly facing reflective side surfaces will be reflected upwardly towards the ceiling of the room or area on the other side of the glazing panel. In this manner, the amount of direct light incident on people in the room is substantially reduced, yet the redirected light still maintains a sufficient degree of natural light in the room or other area.

The elements may be applied directly to the glass or to a film which is applied to the glass. In the latter case, the film may comprise a spectrally selective film which controls the amount of visible light and/or the amount of solar energy passing through the panel.

Whilst the above-mentioned glazing panel provides an extremely effective way of controlling unwanted solar glare and heat caused by sunlight travelling through a glazing panel, there is sometimes the need to be able to vary the amount of the glazing panel covered by the elements and the amount of solar heat gain and heat loss controlled/allowed through the panel, for example to increase the amount of light and or solar energy (heat gain) entering a room on dark or cold days, or to decrease the amount of light and related solar energy entering a room on light days.

I have now devised a device for fitting to a window or other glazing panel which meets the above-mentioned objective.

In accordance with the present invention, as seen from a first aspect, there is provided an energy control device for fitting to a window or other glazing panel, the device comprising a first and second parallel rollers disposed at spaced apart positions on respective opposite sides of the device and an elongate substrate sheet attached at first and second opposite ends thereof to respective rollers, the substrate sheet being provided with a series of spatially separated optical elements disposed on a major face thereof, each element having an optical transmission coefficient which varies across the plane of the substrate and an increased thickness perpendicular to the plane of the substrate at its less optically transmissive side, said side of each element comprising a reflective side face directed generally parallel to the plane of the substrate and facing in substantially the same direction as the corresponding face of adjacent elements of the series, wherein the density of the spatially separated optical elements decreases from said first end of the substrate sheet towards said second end.

In use the device is fitted to a window such that the first and second rollers are respectively positioned adjacent the upper and lower sides of the window and such that the substrate sheet extends across the window. On dark days, the first roller can be actuated to wind in the substrate such that fewer or no elements are disposed across the window or so that the elements are confined to a region disposed at the top of the window. Conversely, on bright light days, the second roller can be actuated to wind in the substrate such that elements are disposed at the upper end of the window or so that the elements extend across the whole window window.

Preferably means are provided for actuating the rollers: this may comprise a pull cord, a slidable member or a motor. In the latter case, the motor may be controlled by a timer device or a light sensor and/or a thermal sensor.

Preferably a stop control means prevents the substrate carrying said elements from being completely wound onto the first roller. This upper position may be pre-set to determine the amount of treated material always on view to control glare and daylight transmission.

Preferably the first and second ends of the substrates are formed of different thermally performing materials which are preferably permanently interconnected intermediate opposite ends of the substrate, although the ends may be separable.

Preferably, at least the first end of the substrate comprises a material which controls the amount of visible light and/or the amount of solar energy (ie short-wave infra-red radiation) entering the room through the window.

Preferably, at least the second end of the substrate comprises a material having a low emissivity: low emissivity or so-called e-value materials are materials which are arranged to reflect or filter long wave infra-red radiation so that in the winter months, much of the warmth (heat) inside the building is reflected back into the building keeping the building warm. In the summer months, the heat from the sun is reflected keeping the building cool. Thus, dependent upon the position of the substrate across the window, energy in the form of short wave and long wave infra red can be allowed to exit or enter the building as desired to control and reduce a buildings energy needs.

Preferably the device comprises side members, each provided with a channel in which a respective side edge of the substrate is received.

Preferably the side members comprise means for sealing against the major faces of the substrate so that the device will insulate the installed window or glazing panel from heat loss and heat gain whilst maximising the amount of daylight able to be transmitted into the interior of the room. The sealing means enable the substrate to move upwards and downwards, whilst preventing the escape of heated or cooled air around substrate into the internal or external environments.

Preferably each roller is disposed within a housing, which is preferably thermally insulated and which preferably sealingly contains the roller.

Preferably the side members each comprise a further channel, arranged to receive opposite side edges of a second substrate sheet.

Preferably the device is arranged to provide a sealed gap between the window and the adjacent substrate sheet and/or between the two substrate sheets. In this manner the device can also act to provide secondary glazing over the window.

The second substrate sheet may comprise a rigid panel of glass, plastics or like material fitted in said further channel.

Alternatively, the device may comprise a third roller, said second substrate sheet being extendable therefrom parallel to said first-mentioned substrate sheet.

The second substrate sheet may be formed of either of the above-mentioned spectrally selective materials of the first substrate.

The second substrate sheet may comprise a series of spatially separated optical elements disposed on a major face thereof, each element having an optical transmission coefficient which varies across the plane of the substrate and an increased thickness perpendicular to the plane of the substrate at its less optically side, said side of each element comprising a reflective side face directed generally parallel to the plane of the substrate and facing in substantially the same direction as the corresponding face of adjacent elements of the series.

In use, the relative position of the two substrate sheets can be varied, for example to align the elements thereon and to thereby increase the density of the elements across a whole or part of the window or to vary the extent of the window obscured by the elements.

Preferably the density of the spatially separated optical elements on the respective substrates varies in different and preferably opposite directions, so that the user can select the degree of light reflected by the elements by appropriately aligning the substrate sheets with each other.

A device in accordance with the present invention thus significantly improves the u value and g factor of the window and so reduces the amount of energy the building consumes, for lighting, cooling and space heating purposes.

Depending upon the arrangement and selection of the materials used for the first and second end of the substrates, the device will provide a number of energy benefits.

Also in accordance with the present invention, as seen from a second aspect, there is provided an assembly comprising a window or other glazing panel provided with a series of spatially separated optical elements disposed on a major face thereof, each element defining a reflective side face directed generally parallel to the plane of the window or other glazing panel and facing in substantially the same direction as the corresponding face of adjacent elements of the series, the assembly further comprising an energy control device having a substrate which is extendable across the window or other glazing panel, the substrate panel being provided with a series of spatially separated optical elements disposed on a major face thereof, each element defining a reflective side face directed generally parallel to the plane of the substrate and facing in substantially the same direction as the corresponding face of adjacent elements of the series.

The optical elements on the window are preferably confined to the end thereof which is mounted uppermost in use. In summer months, the substrate is not extended across the window and the spatially separated optical elements on the upper region of the window serve to reflect the high angle sunlight and so prevent any direct rays from entering the building. The opposite end of the window is preferably clear to allow an unobstructed field of view through the lower region of the window.

In winter months when the sun's angle is lower, the substrate can be extended across the window, such that the spatially separated optical elements on the substrate extend across said opposite end of the window and thereby increase the area of the window that is obscured by the elements.

The optical elements on the substrate are preferably confined to the end thereof which is mounted lowermost in use, the opposite end thereof being clear.

Preferably at least some of the elements have an optical transmission coefficient which varies across the plane of the window or substrate and an increased thickness perpendicular to the plane of the window or substrate at the less transmissive optically side, said side of each element defining said reflective face.

Preferably the elements comprise elongate lines, which in use extend generally horizontally.

Preferably the substrate extends from a roller mounted on one side of the window.

Also in accordance with the present invention, as seen from a third aspect, there is provided a device for insulating a window or other glazing panel, the device comprising a roller, a substrate sheet attached to the roller and a surround for fitting around the window or other glazing panel and arranged to create a substantially sealed pocket of air across the window or other glazing panel when the substrate sheet is extended from the roller across the window or other glazing panel.

In this manner the device acts to provide a form of secondary glazing across the window or other glazing panel, thereby improving the u-value or heat transfer coefficient of the building.

Preferably, the substrate comprises a material having a low emissivity: low emissivity or so-called e-value materials are materials which are arranged to reflect or filter infra-red radiation so that in the winter months, much of the warmth (heat) inside the building is reflected back into the building keeping the building warm. In the summer months, the heat from the sun is reflected keeping the building cool.

Preferably the substrate sheet is provided with a series of spatially separated optical elements disposed on a major face thereof, each element having an increased thickness perpendicular to the plane of the substrate to provide a reflective side face directed generally parallel to the plane of the substrate and facing in substantially the same direction as adjacent elements of the series.

Preferably the density of the spatially separated optical elements decreases from one end of the substrate sheet towards its other end.

Preferably at least some of said elements comprises an optical transmission coefficient which varies across the plane of the substrate and is preferably less transmissive adjacent said reflective side face.

The device may comprise a pair of rollers having respective substrate sheets.

Preferably the substrate sheets are arranged to extend parallel to each other.

In one embodiment, one substrate sheet comprises said filter material and the other comprises said spatially separated optical elements.

The substrate sheets may be extendable independently of each other.

In an alternative embodiment, both substrate sheets comprise said spatially separated optical elements, the density of the spatially separated optical elements preferably varying in different and preferably opposite directions, so that the user can select the degree of light reflected by the elements by appropriately aligning the substrate sheets with each other.

Alternatively, the substrate sheets may be joined together, for example along a leading edge thereof.

Preferably said sealed pocket of air is provided between the substrate sheets. Alternatively or additionally, the sealed pocket of air may be provided between the window or other glazing panel and the adjacent substrate sheet.

Preferably the sides of the or each sheet sealingly extend in channel-shaped side frame members.

Preferably the leading edge of the or each sheet is arranged to seal in or against a bottom frame member.

Preferably the or each roller is sealingly contained in a housing, which preferably has a longitudinal opening arranged to seal against the substrate.

Also, in accordance with the present invention, as seen from a fourth aspect, there is provided a glazing panel, comprising a substrate sheet and a series of spatially separated optical elements disposed on a face of said substrate and defining respective surfaces which extend perpendicular to the plane of said substrate and which are arranged to reflect incident light, the surfaces of adjacent elements facing in substantially the same direction, wherein, only some of said optical elements further comprise an optically transmissive portion arranged to diffuse incident light.

Preferably the elements with optically transmissive portions are confined to a first region of the substrate, for example at a first end thereof. In use, the first end may be mounted uppermost across the window aperture.

Preferably the elements without optically transmissive portions are confined to a second region of the substrate, for example disposed adjacent the first region.

Preferably the optical transmission coefficient of said portions varies across the width of some or all of the elements in a direction parallel to a plane of said substrate, from a first side to a second side of the respective element.

Preferably the first side is less optically transmissive than said second side.

Preferably the first side defines said reflective face.

Embodiments of the present invention will now be described by way of examples only and with reference with accompanying drawings, in which:

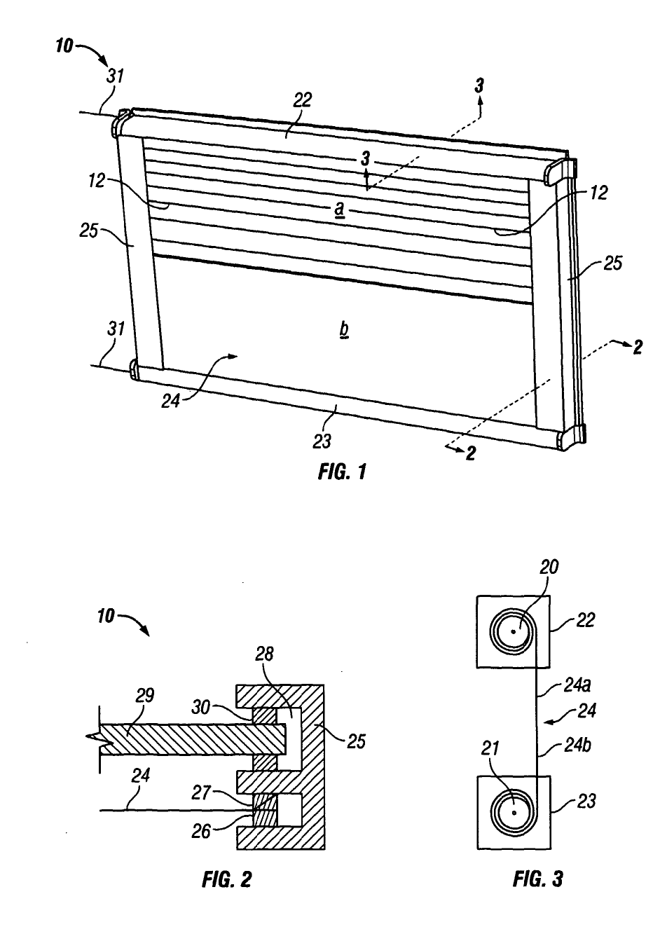

FIG. 1 is a perspective view of an embodiment of device in accordance with the present invention for fitting to a window or other glazing panel;

FIG. 2 is a sectional view along the line II-II of FIG. 1;

FIG. 3 is a sectional view along the line III-III of FIG. 1;

FIG. 4 is a sectional view through the upper substrate of the device of FIG. 1, showing a representation of optical elements thereon;

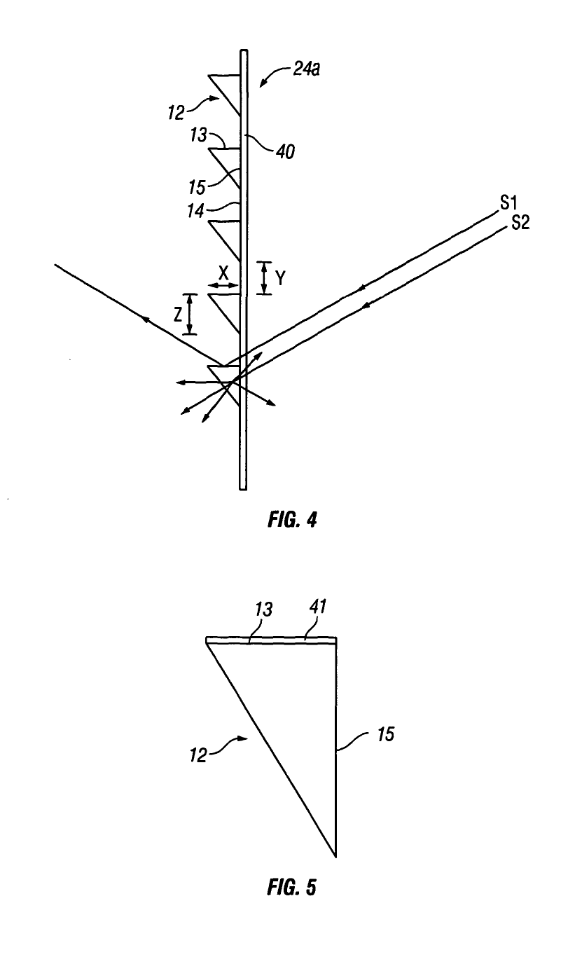

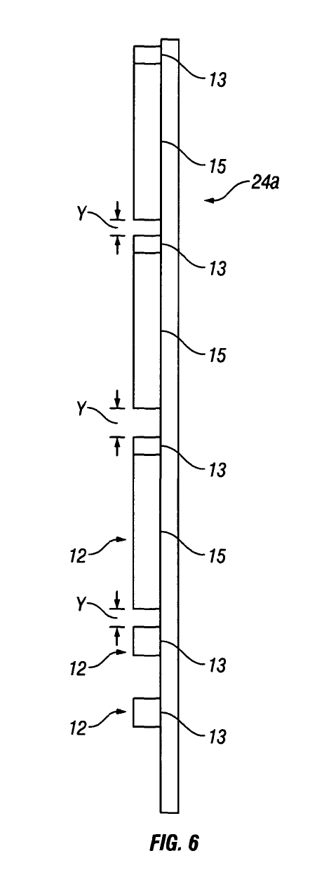

FIG. 5 is an enlarged sectional view of an optical element of FIG. 4;

FIG. 6 is a sectional view through the upper substrate of the device of FIG. 1, showing an alternative representation of optical elements thereon;

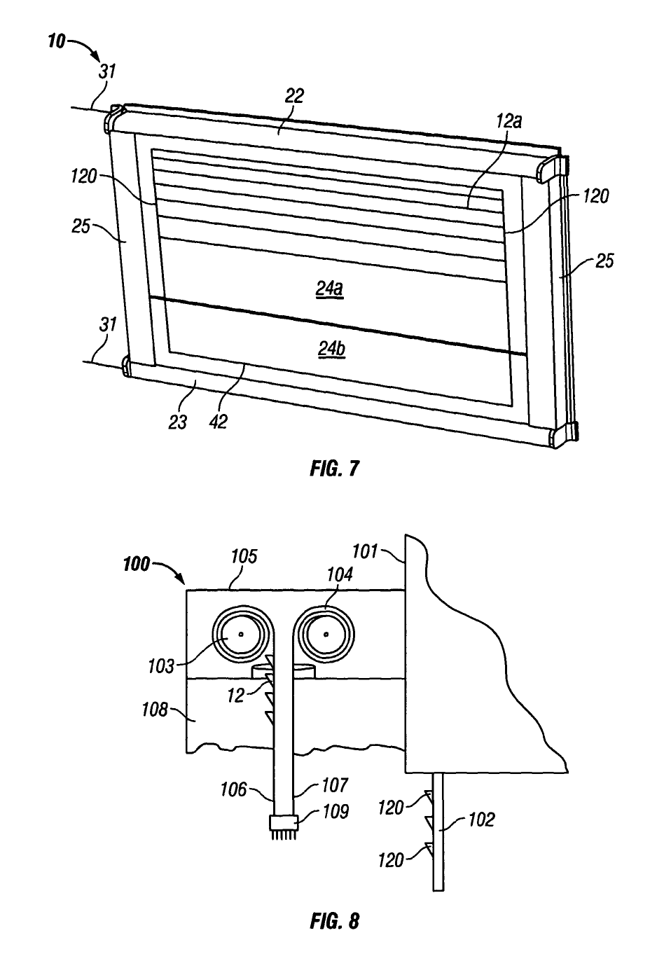

FIG. 7 is a perspective view of the device of FIG. 1 when fitted to a window;

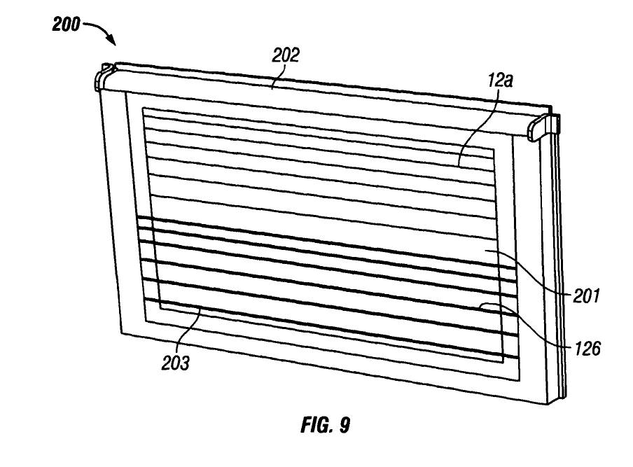

FIG. 8 is a sectional view of an alternative embodiment of device in accordance with the present invention fitted to a window or other glazing panel; and

FIG. 9 is a perspective view of an alternative embodiment of device in accordance with the present invention when fitted to a window or other glazing panel.

Referring to FIGS. 1 to 3 of the drawings, there is shown a device 10 for fitting to an interior surface of a building surrounding a aperture for a window or other glazing panel. The device comprises upper and lower rollers 20, 21, which are sealingly mounted inside respective elongate housings 22, 23, the housings preferably being lined with insulating material (not shown). An elongate substrate sheet 24 is attached at its upper and lower ends to respective rollers 20, 21. The housings 22, 23 are arranged to seal against the front and rear surfaces of the substrate 24.

Opposite side edges of the substrate 24 are respectively received in channels 26 formed in respective side members 25 of the device. The opposing faces of each channel 26 are provided with longitudinally-extending strips or brushes 27 which respectively seal against the inner and outer faces of the substrate 24. Optionally, the side members 25 may be formed with a further channel 28 for receiving a respective side edge of a rigid substrate panel 29, which is preferably formed of glass or a like material. Opposing faces of the channel 28 are preferably provided with longitudinally-extending sealing members 30 which respectively seal against the inner and outer faces of the panel 29. The upper and lower side edges of the glazing panel 29 are preferably received in similar channels (not shown) formed in the upper and lower housings 22, 23 respectively.

The upper end of the substrate 24 comprises a sheet 24a of a spectrally selective plastics material, which controls the amount of visible light and/or the amount of solar energy entering the building through the window. As will be described hereinafter with reference to FIG. 4 or 5, the sheet of material 24a is provided with a plurality of optical elements 12. The lower end of the substrate 24 comprises a sheet 24b of a material having a high u-value which is free of the elements 12.

Referring to FIGS. 4 and 5 of the drawings, the upper sheet 24a of the substrate 24 comprises plurality of elongate optical elements 12, in the form of horizontal parallel lines, which extend between opposite side edges of the substrate material 40.

The optical elements 12 are digitally printed directly onto the inner face of the substrate 24. Each element 12 is generally triangular in section and comprises a generally flat upper surface lying perpendicular to the plane of the substrate 24. The thickness of each element 12 gradually reduces towards the lower side edge thereof. Each element 12 is constructed by depositing a series of white or light coloured pixels, with the thickness of elements 12 being varied by adjusting the spacing between the pixels and/or their degree of overlap: the thickest portion of each element 12 is formed by depositing a denser array of overlapping pixels, whilst the thinner region is formed by depositing pixels which are widely spaced apart. In the example shown, the ink density (i.e. the density of pixels) is varied linearly from 100% at the upper side edge to 10% at the lower side edge, although the elements are not necessarily triangular in section as shown for illustration purposes only.

The upper face of each element 12 defines a so-called light shelf 13 having a height X off the surface of the substrate 24. Each light shelf 13 faces an adjacent unprinted clear region 14 of the substrate 24 having a width Y. The distance X and Y are variable parameters and are preferably equal.

The elements 12 comprise an inner face or so-called glare control panel 15 which are directed through the substrate 24 towards the exterior of the building. The height Z of each glare control panel 15 is also a variable parameter, which preferably varies inversely proportionally to Y.

In use, the sun's rays S1, S2 shine down from the sky through the window and onto the substrate 24. Some of the incident rays e.g. S1 hit the so-called light shelves 13 formed by the upper side faces of elements 12 and are reflected upwardly into the room and redirected at an equal and opposite angle instead of passing downwardly through the substrate onto people or work surfaces within the building. Preferably none of the reflected light is attenuated and thus the level of reflected light entering the room is the same as that which would have passed straight through the panel.

Other incident rays e.g. S2 hit the so-called glare control panel 15, which reflects, attenuates and diffuses the light according to the characteristics of the panel thereby allowing a softer and more diffuse light to shine directly into the room. The colour of the transmitted light can be varied by adjusting the colour of the ink used for the glare control panel 15. The amount of direct light can be varied by adjusting the width Z of the glare control panel 15. The amount of reflected light can be adjusted by varying the height X of the light shelf 13.

In another embodiment the light shelf 13 may be coated with a metallised or reflective layer 41. Alternatively, the reflective layer may be formed by depositing the elements 12 with a more reflective colour at their upper edge.

Referring to FIG. 6 of the drawings, the vertical spacing Y of the elements 12 may gradually decrease or otherwise vary from the top towards the bottom of the upper sheet 24a of the substrate 24. The average optical transmissivity of each glare control panel 15 may also gradually increase or otherwise vary from the top towards the bottom of the upper sheet 24a of the substrate 24. The glare control panel 15 may be absent from some of the elements 12, which solely comprise light shelves 13. These latter 12 elements may be provided in a discrete region on the substrate 24a, for example below a region containing elements 12 with glare control panels 15.

The present invention thus provides a system of designed and printed patterns of varying size and printed intensity that can be digitally placed in desired positions on the printed surface to manage and control the amount of light entering a building. The optical height of the elements off the substrate panel and the density of the elements can be varied to suit particular applications.

Referring again to FIG. 1 of the drawings, means 31 are provided for actuating the rollers 20, 21 to vary the proportions of the substrate sheets 24a, 24b which are disposed across the window aperture. The lower sheet 24b is free of the optical elements 12 and as such more light is allowed into the building when less of the sheet 24a is exposed. The sheet 24b has a high u-value and thus serves to prevent heat escaping from the building during the winter months when less of the upper sheet 24a is likely to be exposed. During summer months, the rollers 20,21 can be actuated to cause more of the upper sheet 24a to be exposed so as to manage and control the amount of light entering the building. It is envisaged that the position of the upper and lower sheets 24a, 24b of the substrate may be controlled automatically according to the time of day, the time of year, the temperature and/or the amount of incident light.

The provision of the optional glazing panel 29 provides a secondary-glazing feature and further helps to insulate the building. The glazing panel 29 may be disposed between the substrate 24 and the window or it may be disposed inwardly of the substrate 24, so as to contain the substrate within an air gap provided between the glazing panel 29 and the window.

Referring to FIG. 7 of the drawings, the device 10 of FIG. 1 may be fitted across a window or other glazing panel 42 provided with optical elements 120 corresponding to the aforementioned elements 12 on the device: the optical elements 12 are omitted for clarity from the region 24a on FIG. 6. The optical elements 120 may be confined to the upper region of the window 42 such that the lower end of the window is unobstructed when the lower sheet 24b is raised. On bright days, the upper end of the sheet 24a is pulled down so that the optical elements 12 thereon are either disposed in front of below the elements 112 on the window 42.

Referring to FIG. 8 of the drawings, there is shown an alternative device 100 fitted to an interior surface 101 of a building surrounding an aperture for a window or other glazing panel 102. The device 101 comprises outer and inner rollers 103,104 which are sealingly mounted inside and elongate housings 105, the housing preferably being lined with insulating material (not shown). Elongate substrate sheets 106,107 are attached to respective rollers 103,104. The housing 105 is arranged to seal against the front and rear surfaces of the respective substrates 106,107.

Opposite side edges of the substrates 106,107 are respectively received in channels 26 formed in respective side members 108 of the device. The opposing faces of each channel 26 are provided with longitudinally-extending strips or brushes 27 which respectively seal against the inner and outer faces of the substrates 106,107. Optionally, the side members 25 may be formed with a further channel 28 for receiving a respective side edge of a rigid substrate panel 29, which is preferably formed of glass or a like material.

The lower ends of the substrates 106,107 are sealingly attached to a bar 109 such that a sealed air gap 110 is formed between the substrates 106,107 which acts as a thermal barrier when the substrate is extended across the window 102. One of the substrates e.g. 106 is provided with optical elements 12 of the kind shown in FIG. 5 or 6 at at least its upper end. The other substrate e.g. 107 may comprise a material having a low e-value. Optical elements 120 may also be provided on the window 102.

Referring to FIG. 9 of the drawings, there is shown an alternative device 200 fitted to an interior surface of a building surrounding an aperture for a window 201. The window 201 is provided with a series of spatially separated optical elements 12a in the form of lines disposed on a major face thereof, each element 12a defining a reflective side face directed generally parallel to the plane of the window 201 and facing in substantially the same direction as the corresponding face of adjacent elements 12a of the series.

The elements 12a are confined to a region at the top of the window 201. The elements 12a are or the kind shown in FIGS. 4 to 7. The lower end of the window 201 is not provided with elements 12a. The elements may be provided on a film which is adhered to the window 201. The film may comprise a material which reflects short wave infra-red radiation (ie the heat of the sun). The film may extend over the whole window 201.

The device 200 comprises a roller (not shown) which is mounted in a housing 202 extending across the upper end of the window 201. A substrate 203 extends from the roller and is extendable across the window 201. The substrate 203 is also provided with similar series of spatially separated optical elements 12b disposed on a major face thereof, each element defining a reflective side face directed generally parallel to the plane of the substrate and facing in substantially the same direction as the corresponding face of adjacent elements of the series.

The elements 12b are confined to a region at the lower leading edge of the substrate 203. The elements 12b are or the kind shown in FIGS. 4 to 7. The upper end of the substrate 203 is not provided with elements 12b. The sunstrate may comprise a low e-value material which reflects long wave infra-red radiation (ie the heat from within the building).

When the substrate 203 is extended, the device 200 forms a sealed air pocket between the window 201 and the substrate 203, thereby improving the u-factor of the window.

In summer months, the substrate 230 is not extended across the window as shown, and the spatially separated optical elements 12a on the upper region of the window 201 serve to reflect the high angle sunlight and so prevent any direct rays from entering the building. The lower end of the window 201 is clear and allows an unobstructed field of view.

In winter months when the sun's angle is lower, the substrate 203 can be extended across the window 201 as shown, such that the spatially separated optical elements 12b on the substrate extend across the lower end of the window 201 and thereby increase the area of the window that is obscured by elements.

The optical elements on the substrate are preferably confined to the end thereof which is mounted lowermost in use, the opposite end thereof being clear.

The present invention provides a simple and effective way of variably controlling the amount of light entering a building and variably controlling the amount of heat entering or leaving the building. It will be appreciated that embodiments of the present invention may comprise one or more aspects of the present invention and the preferred features thereof.

1. An assembly comprising a window or other glazing panel provided with a series of spatially separated optical elements disposed on a major face thereof, each element defining a reflective side face directed generally parallel to the plane of the window or other glazing panel and facing in substantially the same direction as the corresponding face of adjacent elements of the series, the assembly further comprising an energy control device having a substrate which is extendable across the window or other glazing panel, the substrate panel being provided with a series of spatially separated optical elements disposed on a major face thereof, each element defining a reflective side face directed generally parallel to the plane of the substrate and facing in substantially the same direction as the corresponding face of adjacent elements of the series.

2. An assembly as claimed in claim 1, in which the optical elements on the window are confined to the end thereof which is mounted uppermost in use.

3. An assembly as claimed in claim 2, in which the opposite end of the window is transparent.

4. An assembly as claimed in claim 1, in which the optical elements on the substrate are confined to the end thereof which is mounted lowermost in use, the opposite end thereof being transparent.

5. An assembly as claimed in claim 1, in which at least some of the elements have an optical transmission coefficient which varies across the plane of the window or substrate and an increased thickness perpendicular to the plane of the window or substrate at the less transmissive optically side, said side of each element defining said reflective face.

6. An assembly as claimed in claim 1, in which the elements comprise elongate lines, which in use extend generally horizontally.

7. An assembly as claimed in claim 1, in which the substrate extends from a roller mounted on one side of the window.

8. An energy control device for fitting to a window or other glazing panel, the device comprising a first and second parallel rollers disposed at spaced apart positions on respective opposite sides of the device and an elongate substrate sheet attached at first and second opposite ends thereof to respective rollers, the substrate sheet being provided with a series of spatially separated optical elements disposed on a major face thereof, each element having an optical transmission coefficient which varies across the plane of the substrate and an increased thickness perpendicular to the plane of the substrate at its less optically transmissive side, said side of each element comprising a reflective side face directed generally parallel to the plane of the substrate and facing in substantially the same direction as the corresponding face of adjacent elements of the series, wherein the density of the spatially separated optical elements decreases from said first end of the substrate sheet towards said second end.

9. A device as claimed in claim 8, in which means are provided for actuating the rollers.

10. A device as claimed in claim 8, in which a stop control means prevents the substrate carrying said elements from being completely wound onto the first roller.

11. A device as claimed in claim 8, in which the first and second ends of the substrates are formed of different thermally performing materials.

12. A device as claimed in claim 11, in which the ends of the substrate are permanently interconnected intermediate opposite ends of the substrate.

13. A device as claimed in claim 11, in which the ends of the substrate are separable.

14. An device as claimed in claim 11, in which the ends of the substrate are permanently interconnected intermediate opposite ends of the substrate, although the ends may be separable.

15. A device as claimed in claim 8, which comprises side members, each provided with a channel in which a respective side edge of the substrate is received.

16. A device as claimed in claim 15, in which the side members comprise means for sealing against the major faces of the substrate

17. A device as claimed in claim 8, in which each roller is disposed within a housing.

18. A device as claimed in claim 17, in which the housing is thermally insulated and sealingly contains the roller.

19. A device as claimed in claim 15, in which the side members each comprise a further channel, arranged to receive opposite side edges of a second substrate sheet.

20. A device as claimed in claim 19, in which the device is arranged to provide a sealed gap between the two substrate sheets.

21. A device as claimed in claim 8, in which the device is arranged to provide a sealed gap between the window and the substrate sheet.

22. A device for insulating a window or other glazing panel, the device comprising a roller, a substrate sheet attached to the roller and a surround for fitting around the window or other glazing panel and arranged to create a substantially sealed pocket of air across the window or other glazing panel when the substrate sheet is extended from the roller across the window or other glazing panel.

23. A device as claimed in claim 22, in which the substrate comprises a material having a low emissivity.

24. A device as claimed in claim 22, in which the substrate sheet is provided with a series of spatially separated optical elements disposed on a major face thereof, each element having an increased thickness perpendicular to the plane of the substrate to provide a reflective side face directed generally parallel to the plane of the substrate and facing in substantially the same direction as adjacent elements of the series.

25. A device as claimed in claim 24, in which the density of the spatially separated optical elements decreases from one end of the substrate sheet towards its other end.

26. A device as claimed in claim 8, in which at least some of said elements comprise an optical transmission coefficient which varies across the plane of the substrate.

27. A device as claimed in claim 22, comprising a pair of rollers having respective substrate sheets.

28. A device as claimed in claim 27, in which the substrate sheets are arranged to extend parallel to each other.

29. A device as claimed in claim 28, in which the substrate sheets are joined together along a leading edge thereof.

30. A device as claimed in claim 29, in which a sealed pocket of air is provided between the substrate sheets.

31. A glazing panel, comprising a substrate sheet and a series of spatially separated optical elements disposed on a face of said substrate and defining respective surfaces which extend perpendicular to the plane of said substrate and which are arranged to reflect incident light, the surfaces of adjacent elements facing in substantially the same direction, wherein, only some of said optical elements further comprise an optically transmissive portion arranged to diffuse incident light.

32. A glazing panel as claimed in claim 31, in which the elements with optically transmissive portions are confined to a first region of the substrate.

33. A glazing panel as claimed in claim 31, in which the elements without optically transmissive portions are confined to an adjacent second region of the substrate.
